(19) United States
(12) Patent Application Publication
(10) Pub. No.: US 2010/0321134 A1
(43) Pub. Date: Dec. 23, 2010

(54) FLIPPED MICRO-STRIP FILTER

(75) Inventors: Per Ligander, Goteborg (SE); Marcus Hasselblad, Molndal (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 12/446,287

(22) PCT Filed: Oct. 20, 2006
(86) PCT No.: PCT/SE2006/001193

§ 371 Date: Apr. 20, 2009

(51) Int. Cl. H01P 1/203

(52) U.S. Cl. 333/204

(57) ABSTRACT

A filter device for a printed circuit board, wherein the filter device comprises a selected pattern of conductive material arranged to be electromagnetically coupled to an electrically conductive plane comprised in the printed circuit board. The invention is characterized in that the filter device is a separate unit from the printed circuit board and is connectable to the printed circuit board via first connectors positioned on the filter device and second connectors correspondingly positioned onto the printed circuit board.

### TECHNICAL FIELD

The invention concerns a filter device for a printed circuit board. The filter device comprises a selected pattern of conductive material arranged to be electromagnetically coupled to an electrically conductive plane comprised in the printed circuit board.

### BACKGROUND

In the field of printed circuit boards (hereinafter called PCB) for microwave signals it is known to use filters for signal processing in order to obtain good performance of the microwave signal. EP 1653552 teaches a previously known micro-strip filter comprising a number of interspaced strips arranged on the PCB and being electromagnetically coupled to a ground plane in the PCB. The filter is etched in the outer layer of the PCB in the same way as an ordinary printed circuit pattern. The appended FIG. 1 schematically shows a filter device incorporated in the PCB according to prior art.

One problem with the micro-strip filter arranged in the PCB is that the micro-strip filter represents a very small area which puts specific requirements on the manufacturing process. For example, on a PCB, of the size 200×90 mm the micro-strip filter represent an area of about 15×15 mm, (about 1.25%). The micro-strip filter is very sensitive to process variations which is why the manufacturing process must be very accurate to maintain the performance of the filter. Furthermore, the manufacturing requirements put on the filter are the same for the entire PCB because it would be difficult to have different requirements for different parts of the PCB surface. As a consequence, unnecessarily high requirements are put on parts of the PCB where it is not needed, which will add costs to the manufacturing process of the PCB. Furthermore, it is more difficult to maintain high requirements over a large area, such as the PCB area, than to maintain the high requirements over a smaller area such as the micro-strip filter area, since the manufacturing process goes on during a long period of time and since the operation involves larger movements of the machine parts. When manufacturing a PCB and trying to maintain high requirements over the entire PCB area there is therefore a risk that the manufacturing process is disturbed which gives a local drop in accuracy. If the local drop in accuracy occurs in the filter area, the filter is negatively affected and the entire PCB may have to be rejected.

Furthermore, the filter implemented on the PCB needs also to be varied with regard to, for example, different frequencies (i.e. channel dependent), bandwidth, and stop band. For each change in parameter the filter design is affected and thus the PCB design. Hence, for each change of parameter it will be necessary to manufacture a new PCB and this results in increased costs.

Thus, there remains a need for an improved microwave filter for a PCB being easier to manufacture, more flexible with regard to design and cheaper to manufacture.

### SUMMARY

The present invention concerns a filter device for a printed circuit board (hereinafter called also PCB) having features that meet the above described need. The filter device comprises a selected pattern of conductive material arranged to be electromagnetically coupled to an electrically conductive plane in the printed circuit board and being positioned relative each other in such a way that a desired filter behaviour is achieved. Here, plane refers to a layer of electrically conductive material being positioned on one side of a substrate comprised in the PCB or within the substrate. The filter device is preferably a microwave filter arranged for processing a microwave signal.

The invention is characterised in that the filter device is a separate unit from the PCB and preferably formed by layering the selected pattern of conductive material onto a substrate. The filter device is arranged to be connected to the PCB via first connectors positioned on the filter device and second connectors correspondingly positioned onto the printed circuit board. The filter device preferably follows the contour of the PCB in order to be able to be properly fitted to and thus connected to the PCB.

One advantage of the invention is that fewer manufacturing requirements are placed on the PCB in general since the filter device form a separate unit from the PCB. The filter device may thus be designed and manufactured with regard to one type of requirement and the PCB may be manufactured with another type of requirement. The reduced requirements of the PCB reduce the cost for manufacturing the PCB assembly comprising the PCB and the filter device. A further advantage is that a separate filter device may be altered for different filter purposes and applications but may still be connected to the same type of main PCB thus giving a flexible design for the PCB assembly without having to change the PCB.

The filter device according to the invention is arranged to be positioned with the selected pattern of conductive material placed towards the printed circuit board and at a selected distance from the printed circuit board. One advantage of the invention is that the separate filter device gives a smooth electromagnetic transition from the PCB to and through the selected pattern of conductive material and down to the PCB again due to the fact that the ground plane does not have to be lifted from the PCB and because there are no via-holes in the transmission path. Another advantage is that the surface of the conductive material facing the PCB is smooth and not as rough as would be the case should the filter be attached to the PCB. The rough surface is a result of the conductive material being attached to a substrate, in the latter case the substrate comprised in the PCB. In the filter device according to the invention the conductive material is attached to a separate substrate facing away from the PCB and the rough surface therefore faces away from the PCB. The smooth surface itself also improves the electromagnetic transition between the conductive material and the ground plane.

The selected pattern comprises a number of electrically conducting strips being positioned in relation to each other such that they interact electromagnetically in a predictable and desired manner. The length and width of the strips together with the distance between the strips and the selected distance between the PCB and the selected pattern of electrically conductive material are design parameters for the filter structure. The strips are preferably interspaced parallel strips which may be interconnected, for example as in a so called stub filter, or may be separate from each other as in a side coupled micro-strip filter, i.e. an inductive or capacitive coupled filter. Common for all filter devices according to the invention is however that the selected pattern of conductive material interacts electromagnetically internally amongst the strips comprised in the filter device and also with the ground plane comprised in the PCB.

Further advantages of the invention will be apparent in the below detailed description.

### BRIEF DESCRIPTION OF THE DRAWINGS

The invention will below be description in further detail in connection to a number of drawings, in which:

FIG. 1 schematically shows a printed circuit board according to prior art;

FIG. 2 schematically shows a printed circuit board and a filter device according to the present invention, and;

FIG. 3 schematically shows a cross-sectional side view of a filter device according to the invention and a part of a portion A of a PCB along the lines III-III in FIG. 2.

### DETAILED DESCRIPTION

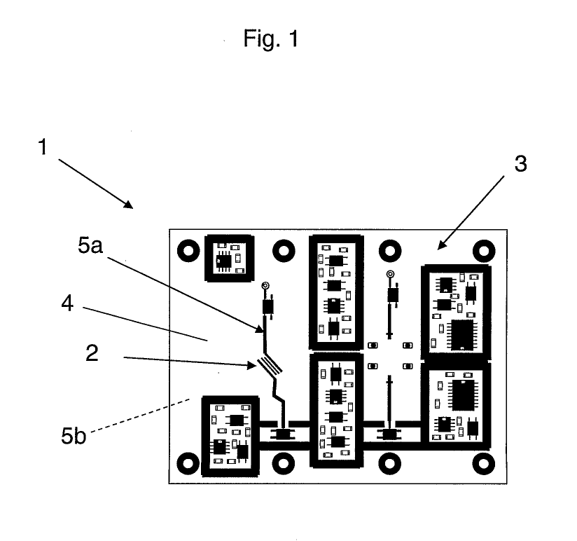

FIG. 1 schematically shows a printed circuit board (hereinafter called PCB) 1 according to prior art. The PCB 1 comprises a previously known filter device 2 being part of a pattern of printed circuits layered onto a primary surface 3 of the PCB 1. The disadvantages of the prior art have been discussed above when describing prior art. The PCB 1 comprises a substrate 4 of non-conductive or dielectric material onto which a conductive layer 5a in the form of the printed circuits are formed, for example by etching, and a ground layer 5b. The filter device 2 operates by the conductive layer in the filter being electromagnetically coupled to the ground layer 5b. The PCB 1 may also comprise a number of layers of substrates and conductive material for use in more complex circuit board arrangements.

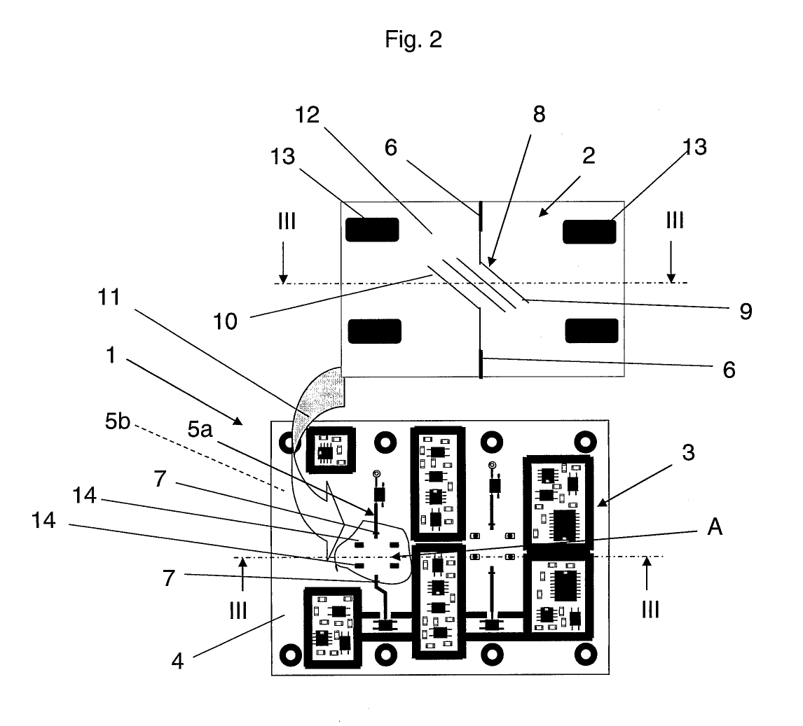

FIG. 2 schematically shows a PCB 1 and a filter device 2 according to the present invention. The PCB 1 used together with the filter device 2 according to the invention is preferably identical to the PCB 1 described in connection to FIG. 1. The filter device 2 is a separate unit from the PCB 1 and is connectable to the PCB 1 via first connectors 6 positioned on the filter device 2 and second connectors 7 correspondingly positioned onto the PCB 1. The filter device 2 comprises a selected pattern of conductive material comprising a number of interspaced strips 8. The filter device 2 comprises a first strip 9 being electrically coupled to one of the first connectors 6 and a second strip 10 connected to another first connector 6. In FIG. 2 the first strip 9 and the second strip 10 are the two strips being positioned the farthest away from each other, i.e. the first and second strips 9, 10 are the outermost flanked and opposite strips of all strips in the filter device 2. All the strips 8, not including the first and second strips 9, 10, are positioned with selected distance between them and they are positioned between the first and the second strip 9, 10. The distance between the strips 8, the width of the strips 8, the length of the strips 8, the thickness of the strips 8 and the relative position to each other are all design parameters that has to be taken into account when designing and manufacturing the filter device 2.

One benefit of the invention is that the filter device 2 may be re-designed without having to manufacture an entire PCB 1. It is enough to manufacture a new filter device 2 and to replace the old filter device 2 from the PCB 1 with the new. Another advantage is that a number of different filter devices 2 may be manufactured to achieve a high standard with regard parameters such as tolerances etc. while a number of PCBs 1 may be manufactured with a lower standard regarding the same parameters. Furthermore, since the filter device 2 is a small component compared to the PCB 1 there is less risk of tolerance variations when manufacturing the filter device 2.

Yet a further advantage is that in an assembly line there may be a large number of identical PCBs 1 and a number of different filter devices 2, and a suitable filter device 2 may be chosen in situ in the assembly line depending on the type of filter device being required.

In FIG. 2 the filter device 2 is shown in a position where it is not attached to the PCB 1, but an arrow 11 is shown in FIG. 2 indicating that the filter device 2 is flipped so that the strips 8 face the primary surface 3 upon assembly onto the PCB 1, i.e. the filter device 2 is arranged to be positioned with the selected pattern of conductive material towards the printed circuits 5a on the PCB 1. Furthermore, in order for the filter device 2 to fit onto the PCB 1 the first connectors 6 must fit the second connectors 7. The first connectors 6 are preferably interspaced in order to fit the first and second strips 9, 10 and the second connectors 7 are then interspaced in a corresponding manner.

In FIG. 2 the filter device 2 comprises a substrate 12 onto which the selected pattern of conductive material, i.e. the strips 8, is layered. The substrate 12 and the conductive material 8 thus form a separate unit that may be easily managed by an operator in an assembly line. The substrate 12 may be of the same material as the non-conductive or dielectric material forming a layer in the PCB. The dielectric material provides a designer with a further parameter when designing the filter device since dielectric material has an impact on the filter behaviour.

In FIG. 2 the filter device 2 comprises a number of first alignment pads 13 positioned at each corner of a rectangular filter device 2. The geometrical shape of the substrate 12, i.e. the filter device 2, is not restricted to a rectangular shape, but may be triangular, multi-angular, oval, circular, or any other suitable shape. The number of first alignment pads 13 are not restricted to four but may be varied from one to a number of first alignment pads 13 depending on, for example, the geometrical shape of the substrate etc. The PCB 1 comprises corresponding second alignment pads 14. The first and for the second alignment pads 13, 14 may be in the form of a specially formed solder stop encompassing a solder material. The filter device 2 may then be soldered into place on the PCB 1 by use of the first and second alignment pads 13, 14 and the solder stops automatically align the filter device 2 due to the surface tension in the liquefied solder material. However, the first and second alignment pads 13, 14 may be any suitable means for attaching the filter device 2 to the PCB 1, for example, glue and mechanical fasteners, etc., as long as the first and second connectors 6, 7 connect in a proper manner. The first and second connectors 6, 7 may also be permanently connected by a suitable attachment means, for example by use of soldering technique, an adhesive such as glue, or the like.

In FIG. 2 the PCB 1 has an extension in a plane and a thickness in a direction perpendicular to the plane. The filter device 2 preferably has an extension in a plane being parallel to the plane over which the PCB 1 has an extension. However, should the PCB 1 have an extension in three dimensions, i.e. an extension over a curved surface or the like, the filter device 2 may have a similar extension over a curved surface being parallel to the curved surface over which the PCB 1 has the extension.

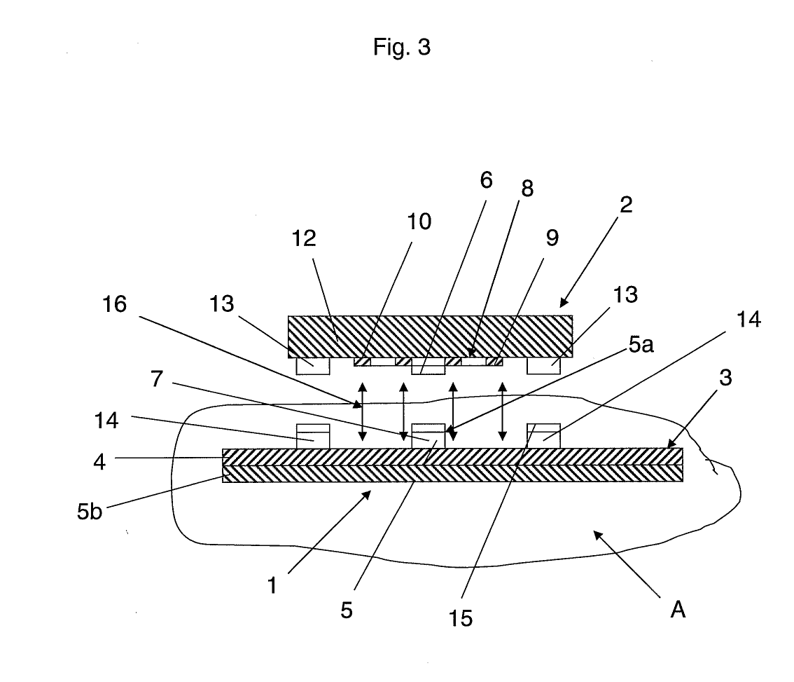

FIG. 3 schematically shows a cross-sectional side view of a filter device 2 according to the invention and a portion A of the PCB along the lines III-III in FIG. 2. In FIG. 3 the filter device 2 is arranged to be positioned with the selected pattern of conductive material, i.e. the strips 8, at a selected distance from the PCB 1. The selected distance is a result of the fact that the first and second connectors 6, 7 are connected via an attachment layer 15, for example, a solder layer, and that these layers gives a height which form the selected distance. The selected distance forms a design parameter that is used when designing the filter device and the air between the filter device and the PCB has to be taken into account as it is a dielectric substance.

An ideal solution of the invention would have been to let the conductive material 8 hang in the air a couple of micrometers from the surface of the PCB 2, but this is not possible due to the construction of the strips, i.e. for example in the case where the strips are separated they do not form a continuous structure. Therefore, the strips 8 are placed on the substrate 12 which dependent on design parameters may be formed from a dielectric material or a non-conductive material.

In FIG. 3 it is depicted with double pointed arrows 16 that the filter device 2 is electromagnetically coupled to the ground layer 5b. The filter device according to the invention thus differ from filter devices in the form of components where the signal processing is carried out in the component and where the component is attached to a voltage layer and a ground layer in a PCB for power feeding purposes only. The filter device 2 according to the invention is instead fed power (current) from the PCB 1 via the first and second connectors 6, 7 and when the current then passes the selected pattern of conductive material 8, an electromagnetic field is created in the conductive material 8 and the pattern of the conductive material 8 affects the electromagnetic field, by for example interference. The electromagnetic field is further changed by the electromagnetic coupling between the selected pattern of conductive material 8 and the ground plane 5b.

A can be seen in FIG. 3, the conductive material 8 in the filter device 2 is positioned on the substrate 12 so that the conductive material 8 faces the PCB 1. One benefit with this solution is that the inevitable rough surface on the conductive material 8, being the result of the conductive material being attached to the substrate 12, is positioned away from the PCB 1. As an effect of the rough surface facing away from the PCB, the electrical field will concentrate from the smooth surface of the conductive material 8 facing the PCB 1 down trough the air in the space between the PCB 1 and the filter device 2 and further down into the substrate 4 of the PCB 1 before it meets the ground plane 5b, with a reduced loss in transmission of electromagnetic energy as a consequence. The loss can be further reduced by using a suitable surface treatment, for example silver or gold plating on a cupper

What is claimed is:

1.-11. (canceled)

12. A filter device, comprising:
a selected pattern of conductive material; and
a printed circuit board, the selected pattern of conductive material arranged to be electromagnetically coupled to an electrically conductive plane comprised in the printed circuit board wherein the filter device is a separate unit from the printed circuit board and is connectable to the printed circuit board via first connectors positioned on the filter device and second connectors correspondingly positioned onto the printed circuit board.

13. The filter device according to claim 12, wherein the selected pattern of conductive material further comprises a number of interspaced electrically conducting strips being positioned in relation to each other such that they interact electromagnetically in a predictable and desired manner.

14. The filter device according to claim 13, wherein a first strip is electrically coupled to one first connector and a second strip is connected to another first connector, wherein the number of interspaced strips, excluding the first and the second strips are positioned between the first and the second strip.

15. The filter device according to claim 12, wherein the first connectors are interspaced and the second connectors are interspaced in a corresponding manner.

16. The filter device according to claim 12, wherein the filter device comprises a substrate onto which the selected pattern of conductive material is layered.

17. The filter device according to claim 16, wherein the filter device is positioned with the selected pattern of conductive material towards the printed circuit board.

18. The filter device according to claim 17, wherein the filter device is arranged to be positioned with the selected pattern of conductive material at a selected distance from the printed circuit board.

19. The filter device according to claim 12, wherein the filter device has an extension in a plane being parallel to a plane over which the printed circuit board has an extension.

20. The filter device according to claim 12, wherein the filter device has an extension over a curved surface being parallel to a curved surface over which the printed circuit board has an extension.

21. The filter device according to claim 12, wherein the filter device is a microwave filter arranged for processing a microwave signal.

22. The filter device according to claim 12, wherein the pattern of conductive material comprises interspaced strips being separated from each other and/or electrically interconnected to each other.
